(19) United States
(12) Patent Application Publication
(10) Pub. No.: US 2026/0338817 A1
(43) Pub. Date: Oct. 29, 2026

(54) DEVICE FOR MEASURING THE ROTATIONAL SPEED OF AN AIRCRAFT PROPELLER

(71) Applicant: SAFRAN HELICOPTER ENGINES, Bordes (FR)

(72) Inventors: Thomas KLONOWSKI, Moissy-Cramayel (FR); Camel SERGHINE, Moissy-Cramayel (FR); Thomas DROUIN, Moissy-Cramayel (FR); Jérôme IRIGOYEN, Moissy-Cramayel (FR)

(73) Assignee: SAFRAN HELICOPTER ENGINES, Bordes (FR)

(21) Appl. No.: 19/116,046

(22) PCT Filed: Sep. 26, 2023
(86) PCT No.: PCT/FR2023/051478

§ 371 Date: Mar. 27, 2025

(30) Foreign Application Priority Data
Sep. 30, 2022 (FR) FR2209965

(51) Int. Cl. G01P 3/36

(52) U.S. Cl. CPC G01P 3/36

(57) ABSTRACT

Device for measuring a rotational speed of a propeller of an aircraft including: an optical speed sensor; an optical fiber connected to the optical speed sensor and intended to be connected to a control unit of the aircraft; and at least one target configured to track the rotation of the propeller, the optical speed sensor being configured to detect the target.

### TECHNICAL FIELD

The present invention relates to the general field of phase synchronisation between the propellers of an aircraft, and more particularly to measuring the rotational speed of these propellers to allow such synchronisation.

### PRIOR ART

Climate change is a major concern for many legislative and regulatory bodies worldwide. In fact, various restrictions on carbon emissions have been, are being or will be adopted by various states. In particular, an ambitious standard is being applied both to new aircraft types and to those currently in circulation, requiring the implementation of technological solutions to bring them into line with current regulations. For several years now civil aviation has been mobilising to make its contribution to the fight against climate change.

Technological research efforts have already significantly improved environmental aircraft performance. The applicant is taking into consideration those factors impacting all phases of design and development to obtain aeronautical components and products which consume less energy, are more respectful to the environment and integration and use of which in civil aviation have moderate environmental impacts, with the aim of improving the energy efficiency of aircraft.

Consequently, the applicant is working ongoing on reducing its climate impact by employing ethical development and manufacturing methods and processes which minimise greenhouse gas emissions to the bare minimum to reduce the environmental footprint of its activity.

This sustained research and development work focuses on both new generations of aircraft engines, lightening of apparatus, especially by way of materials used and lighter onboard equipment, developing the use of electric technologies to ensure propulsion, and aeronautical biofuels as an essential complement to technological progress.

To improve market acceptability of new aircraft, especially electric turboprop aircraft, phase synchronisation (‘synchrophasing’) of the propellers of the aircraft is planned to reduce the noise felt inside the aircraft. The aim is to ensure that the noise signature of these new electric turboprop aircraft does not exceed that of currently existing aircraft. In practice, this typically means using phase synchronisation between the propellers to achieve noise reduction relative to the current thermal turboprops of around 25 dB for the usual noise level experienced inside the aircraft, which can range from 85 dB to 100 dB.

As is known, phase synchronisation between propellers involves measuring the rotational speed of the propellers of the aircraft, which is used to then synchronise the speed and angle of rotation of these propellers. This measurement is usually taken using inductive or Hall-effect sensors. However, in the case of propellers driven by medium-to high-power electric thrusters, the already restrictive environment of the sensors, particularly in terms of vibration and temperature, is compounded by electromagnetic interference associated with the electric power of the thrusters. The electromagnetic susceptibility of the sensors normally used is too low, reducing the accuracy of their measurements.

It is therefore preferable to have a reactive and precise measuring device of the rotational speed of propellers, which has low sensitivity to electromagnetic interference.

### EXPLANATION OF THE INVENTION

In this respect, the invention is the result of technological research focused on significantly improving aircraft performance, and in this sense contributes to reducing the environmental impact of aircraft. For this, the invention relates to a measuring device of a rotational speed of an aircraft propeller comprising:
an optical speed sensor;
an optical fibre connected to the optical speed sensor and intended to be connected to a control unit of the aircraft; and
at least one target configured to follow the rotation of the propeller,
the optical speed sensor being configured to detect the target.

The optical fibre is completely immune to electromagnetic interference, as is the optical speed sensor. This produces a measuring device of the rotational speed of a propeller which is completely insensitive to its electromagnetic environment, especially to interference associated with electric cables or converters using power electronics. Because of this speed measuring of the propeller, the control system of the aircraft will be able to precisely and constantly verify whether the propeller has the same speed as the other propellers.

According to a particular characteristic of the invention, the optical speed sensor is fastened to a fixed part of an engine driving said propeller.

It is for example fastened to the fixed structure supporting the engine, ensuring that the optical speed sensor can be less subject to vibrations from the propeller and the engine.

According to another particular characteristic of the invention, the optical fibre is placed along a wing of the aircraft comprising said propeller.

It can run along the leading edge of the wing for example. This advantageously reduces the length of optical fibre needed, as it enables the optical speed sensor and the control unit of the aircraft to be connected by the shortest path. Also, this is of benefit to already existing feed-through facilities for cables or electric wire strands connecting the power supply (converters) to the electric propeller engines, to guide the optical fibre to the control unit of the aircraft. A thermal protective sheath of the fibre will be advantageously provided, which will protect the optical fibre from high temperatures, especially those generated by the high-voltage power cables when the fibre runs along the leading edge of the wing. This thermal protection is made of polymer such as polytetrafluoroethylene (PTFE), for example.

The optical fibre can also run along the trailing edge of the wing. This means having the optical fibre routed in an uncluttered area of the wing. Also, by passing through the trailing edge the optical fibre is sufficiently distanced from the power supply cables which can undergo significant self-heating, and the thermal protection layer can be dispensed with.

According to an embodiment of the invention, the target is placed on a shaft of the engine driving said propeller or on a shaft bearing said propeller, and the optical speed sensor is placed on a radial axis, perpendicular to the axis of rotation of the shaft of the engine or of the shaft bearing said propeller.

Radial measurements can be taken to determine the rotational speed of the propeller by placing the target on the shaft engine or propeller shaft. This arrangement integrates the optical sensor as closely as possible to the mobile component bearing the measuring targets. This proximity ensures minimal mechanical clearance between the fixed part bearing the sensor and the mobile component bearing the targets. In other words, this ensures minimum relative shifts due to vibratory phenomena, between the mobile component and the sensor taking the measurement. This improves the measuring precision and its invariance relative to vibratory conditions.

According to another embodiment of the invention, the target is placed on a flange fastened to the shaft of the engine driving said propeller or to the shaft bearing said propeller, and the optical speed sensor is opposite the flange according to a direction parallel to the axis of rotation of the shaft of the engine or of the shaft bearing said propeller.

Axial measurements of the rotational speed of the propeller can be made by placing the target on a piece rotating with the propeller.

According to a particular characteristic of the invention, the target is a shape and/or a colour contrast and/or a hole

The target can for example be a particular shape appearing on the engine shaft, the shaft bearing the propeller or the flange fastened to one of these two shafts. For example, the shaft or the flange can be toothed and the target can be formed by a tooth or a hollow between two teeth or again by a hole present on the shaft or the flange.

Also, the target can also be a patch of colour or contrasting with the background colour present on a shaft or the flange, the patch of colour for example can be formed by white paint and/or reflective paint.

The target can also be formed by a coloured mark or shape for improved detection by the optical sensor. It can for example be formed by a tooth painted white present on the shaft of the engine, or the shaft bearing the propeller or even the flange, the shafts and the flange in this case being dark in colour.

According to a particular characteristic of the invention, the device comprises a plurality of targets and the optical speed sensor is configured to detect the plurality of targets.

Having several targets can improve the precision of the speed measurement. In addition, all the targets can be identical or the choice can be made to have different targets. According to another aspect, the targets can be equidistant from one another or not. Having different targets and/or non-equidistant targets can help detect the direction of rotation of the propeller, in addition to measuring the rotational speed.

According to another particular characteristic of the invention, the distance between the target or the targets and the optical speed sensor is comprise between 1 mm and 10 mm.

Another aim of the invention is an aircraft comprising a plurality of propellers, wherein each propeller comprises a measuring device according to the invention.

In this way, in this aircraft, each propeller of the aircraft comprises a measuring device according to the invention. Also, all the devices can be identical or different. For example, the choice can be made to have the optical fibres routed along the leading edge for the propellers present on a wing and along the trailing edge for the propellers present on the other wing. For some propellers, the optical speed sensors can also be placed axially opposite a flange fastened to the shafts of the engine or the shafts bearing these propellers, and for other propellers the optical speed sensors are placed on an axis radial to the axis of rotation of the shafts of the engine and the shafts bearing these other propellers. The number of targets between the different propellers, and/or the type of targets and/or the distances between the targets of the same propeller, etc . . . can still be varied.

### BRIEF DESCRIPTION OF THE DRAWINGS

Other characteristics and advantages of the present invention will emerge from the following description, in reference to the attached drawings which illustrate embodiments devoid of any limiting character.

FIG. 1A schematically and partially illustrates a wing of an aircraft comprising three propellers whereof the rotational speed is measured by a measuring device according to an embodiment of the invention.

FIG. 1B schematically and partially illustrates a close-up of the wing of an aircraft, in particular on the one of the turboprops attached to one of the propellers of FIG. 1A.

FIG. 2A schematically and partially illustrates a measuring device of the rotational speed of a propeller according to another embodiment of the invention.

FIG. 2B schematically and partially illustrates the targets of the measuring device of the FIG. 2A.

FIG. 3 schematically and partially illustrates a measuring device of the rotational speed of a propeller according to another embodiment of the invention.

### DESCRIPTION OF EMBODIMENTS

The invention is described hereinbelow in the specific context of aircraft comprising electric propellers. An electric propeller designates the assembly comprising a propeller and an electric engine driving this propeller.

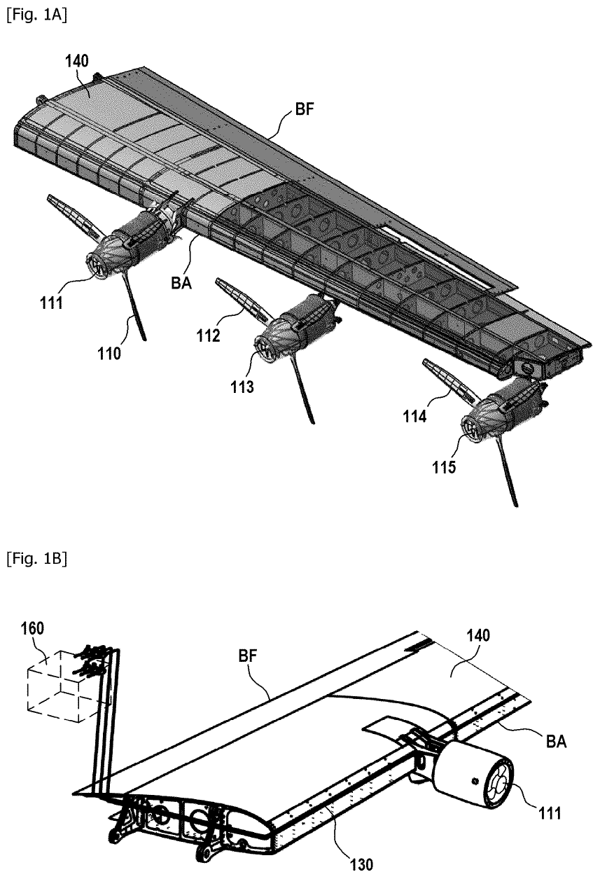

FIGS. 1A and 1B schematically and partially illustrate a wing 140 of an aircraft comprising three propellers 110, 112, 114 each connected to a respective electric engine 111, 113, 115, and the rotational speed of each can be advantageously measured by a measuring device such as will be described hereinbelow.

The measuring device of the rotational speed of a propeller, such as the propeller 110, 112 or 114, comprises an optical speed sensor, an optical fibre 130 connected to the optical speed sensor and to a control unit 160 of the aircraft and at least one target configured to track the rotation of the propeller in question. The optical speed sensor is configured to detect the target or targets. The control unit 160 can comprise an optical signal to digital logic signal converter to interpret the measurements of the optical speed sensor. Because the optical fibre is immune to electromagnetic interference, the optical signal is transported undisturbed from the optical speed sensor to the control unit 160. This contributes to the accuracy of the propeller speed measurement in question.

In reference to FIG. 1B, in this embodiment the optical fibre 130 is placed along the leading edge BA of the wing 140 which comprises the propeller in question, the propeller 110 for example. This reduces the length of optical fibre 130, as it is placed as closely as possible to the speed sensor and runs through the shortest trajectory between the speed sensor and the control unit 160. A protective thermal layer can enclose this optical fibre 130 to protect it especially from the heat generated by the high-voltage power cables generally routed along the leading edge BA of the wing 140, and which feed the electric engine of the propeller 110. The thermal protection can be made of polymer material, for example PTFE.

Alternatively, the choice can be made to have the optical fibre 130 routed along the trailing edge BF of the wing 140 if the clutter of services is to be reduced (such as for example the high-voltage power cables, the feathering actuators of the propeller, servomotors, . . . ) running along the leading edge BA or if the aim is to apply thermal protection to the optical fibre 130.

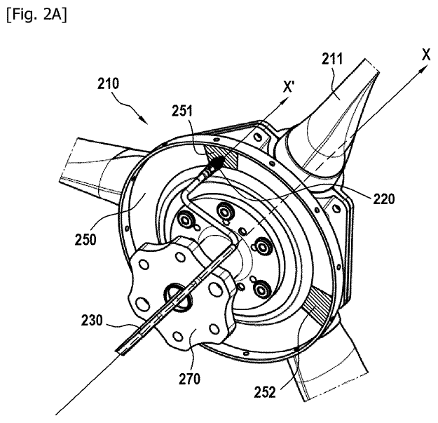

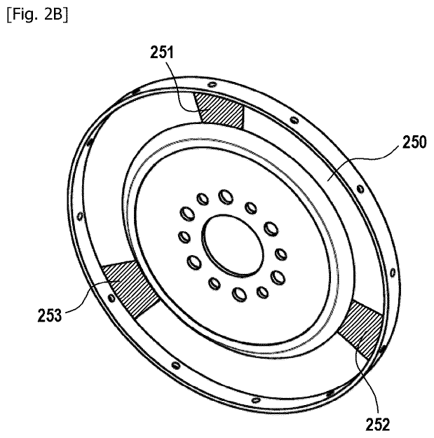

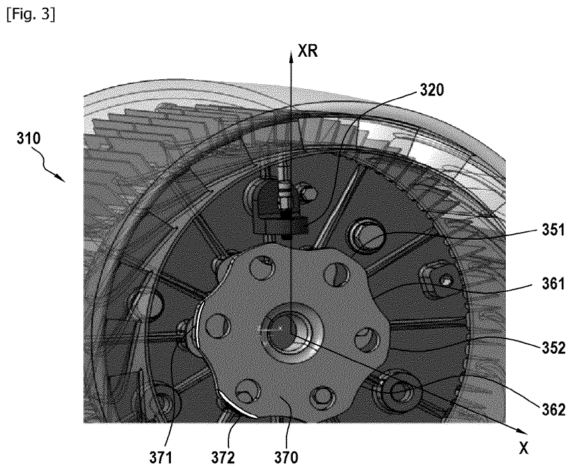

The measuring device of the rotational speed of the propellers 110, 112 and 114, especially the optical speed sensor and the targets is described in more detail hereinbelow in the description with reference to FIGS. 2A, 2B and 3.

FIG. 2A schematically and partially illustrates a measuring device 210 of the rotational speed of a propeller, represented by the propeller 211 in FIG. 2A, according to an embodiment of the invention, which has the advantage in the aerodynamic plane of having no effect on the drag of the aircraft. FIG. 2B illustrates the three targets 251, 252 and 253 of the device 210 of FIG. 2A.

As indicated in reference to FIGS. 1A and 1B, the measuring device 210 comprises an optical speed sensor 220, an optical fibre 230 connected to the optical speed sensor 220 and to a control unit of the aircraft, as well as at least one target 251, 252, 253 configured to track the rotation of the propeller 211. In this example, the device 210 comprises three targets 251, 252, 253 (the third target is not visible in FIG. 2A, but is visible in FIG. 2B) which are placed equidistant relative to each aux other. The optical speed sensor 220 is therefore configured to detect these three targets 251, 252, 253.

The targets 251, 252, 253 are placed on a flange 250 fastened to the shaft 270 bearing the propeller 211. In this example, they are formed by a colour contrast on the flange 250. If the flange 250 is dark in colour, for example black or dark grey, the targets 251, 252, 253 are a light colour, such as white. Or on the contrary, if the flange 250 is light in colour, the targets 251, 252, 253 can be a dark colour. The contrast between the targets to be detected and the background can be heightened by use of reflective paint or on the contrary by absorbent paint for the targets.

The optical speed sensor 220 is fastened to a fixed part of the engine driving the propeller 211, and plus particularly, it is placed opposite the flange 250 according to a direction X′ parallel to the axis of rotation X of the shaft 270 bearing the propeller 211. The axial installation of the speed sensor 220 relative to the longitudinal axis of the engine (axis X), as integrated and profiled in the housing of the propeller engine of the propeller 211, ensures that the drag of the machine is not disturbed on the aerodynamic level.

In this example, the targets 251, 252, 253 are present on a flange 250 fastened to the shaft 270 bearing the propeller 211, but they can in turn be present on another flange or another piece fixed to the shaft of the engine driving the propeller 211, such as for example a flange of large diameter. If this is the case, the optical speed sensor 220 will be opposite this new flange or this new piece according to a direction parallel to the axis of rotation of the shaft of the engine.

FIG. 3 schematically and partially illustrates a measuring device 310 of the rotational speed of a propeller according to another embodiment of the invention.

As in the first embodiment which has just been described, the measuring device 310 comprises an optical speed sensor 320, an optical fibre (not shown in FIG. 3) connected to the optical speed sensor 320 and to a control unit of the aircraft as well as at least one target 351, 352, 361, 362, 371, 372 configured to track the rotation of the propeller.

In this second embodiment, as will be described later, the sensor and associated targets are more closely integrated into the internal part of the motor, which is more conducive to guaranteeing minimal mechanical play, which in a vibratory environment minimises the relative displacement between the fixed sensor and the moving member rotating with the propeller and carrying the targets. This improves measurement accuracy and invariance to vibratory conditions.

In more detail, the optical speed sensor 320 is fastened to a fixed part of the engine driving the propeller. More particularly, in this example it is fastened to a fixed structure supporting or enclosing the engine, and it is placed on an axis XR radial to the axis of rotation X of the shaft and its flange 370. For measuring the rotational speed of the propeller, the optical speed sensor 320 is also configured to detect at least one of the groups of targets (351, 352), (361, 362), and (371, 372).

The targets are placed on a component of the engine driving the propeller, which is mobile in rotation with the propeller, in the example illustrated, a front flange 370 of the shaft engine and more precisely on the tranche of this mobile component. These targets can be of several types: the targets 351, 352 and 371, 372 are bumps or protuberances formed on the tranche of the mobile component, in particular, the targets 371, 372 also exhibit a colour contrast relative to the targets 351 and 352; and the targets 361, 362 are holes, especially hollow shapes formed on the tranche of the mobile component. If the sensor 320 is configured to detect several groups of these targets (351, 352), (361, 362), and (371, 372), it could also determine the direction of rotation of the propeller if for example the groups of targets are different in contrast or if the targets are not placed equidistantly.

In this example, the targets 351, 352, 361, 362, 371, 372 were present on the front flange 370 of the shaft engine driving the propeller. In a variant, the targets could be present on the shaft of the engine driving the propeller. If this is the case, the optical speed sensor 320 will be placed on an axis radial to the axis of rotation of the shaft of the engine.

For the two embodiments described in reference to FIGS. 2 and 3, the optical fibre runs along the wing as far as the propeller the rotational speed of which is to be measured, either along the leading edge or along the trailing edge.

If the wing, or more generally the aircraft, includes several propellers, at least two propellers, the speeds of rotation of which are to be measured, as many devices according to the invention as there are propellers could be put in place. The optical fibres of each of these devices could all run along the leading edges or along the trailing edges of the wings of the aircraft, or could even be distributed between the two wing edges of the aircraft to optimise the space requirement in the wings.

As for the targets present in each of these devices, their number could vary between devices, as well as their shape or location.

Irrespective of the embodiment, if several targets are present in the measuring device, they could be equidistant from one another or placed at variable distances, if the aim also is to determine the direction of rotation of the propeller.

Irrespective of the embodiment, the distance between a target and the optical speed sensor is between 1 mm and 10 mm.

Irrespective of the embodiment, the optical speed sensor is an optical sensor exhibiting precision of less than a degree. For example, it is a slot or circular sensor.

1. A device for measuring a rotational speed of a propeller of an aircraft comprising:
an optical speed sensor;
an optical fibre connected to the optical speed sensor and intended to be connected to a control unit of the aircraft;
and
at least one target configured to track the rotation of the propeller,
the optical speed sensor being configured to detect the target, and the target is placed on a flange fastened to the shaft of the engine driving said propeller or to the shaft bearing said propeller, and the optical speed sensor is opposite the flange according to a direction parallel (X′) to the axis of rotation (X) of the shaft of the engine or of the shaft bearing said propeller.

2. The measuring device according to claim 1, wherein the optical speed sensor is fastened to a fixed part of an engine driving said propeller.

3. The measuring device according to claim 1, wherein the optical fibre is placed along a wing of the aircraft comprising said propeller.

4. The measuring device according to claim 1, wherein a thermal protective layer encloses the optical fibre.

5. (canceled)

6. (canceled)

7. The measuring device according to claim 1, wherein the target is a shape and/or a colour contrast and/or a hole.

8. The measuring device according to claim 1, comprising a plurality of targets and the optical speed sensor being configured to detect the plurality of targets.

9. Aircraft comprising a plurality of propellers, wherein each propeller comprises a measuring device according to claim 1.
